(19) United States
(12) Patent Application Publication
(10) Pub. No.: US 2025/0119736 A1
(43) Pub. Date: Apr. 10, 2025

(54) ENABLING AUTHENTICATION AND KEY MANAGEMENT FOR APPLICATION SERVICE FOR ROAMING USERS

(71) Applicant: ZTE Corporation, Shenzhen (CN)

(72) Inventors: Peilin LIU, Shenzhen (CN); Shilin YOU, Shenzhen (CN); Zhen XING, Shenzhen (CN); Yuze LIU, Shenzhen (CN)

(21) Appl. No.: 18/982,632

(22) Filed: Dec. 16, 2024

Related U.S. Application Data
(63) Continuation of application No. PCT/CN2023/070693, filed on Jan. 5, 2023.

(51) Int. Cl. H04W 12/06; H04W 12/041; H04W 12/75

(52) U.S. Cl. CPC H04W 12/06; H04W 12/041; H04W 12/75

(57) ABSTRACT

This document describes methods, apparatus, and systems that relate to enable Authentication and Key Management for Application service for roaming users. In one example aspect, a method for wireless communication includes receiving, by a network device in a first network from a network device in a second network, a signal indicative of an authentication result related to a wireless device, wherein the signal includes a first key and an indication in case that the first network is different from the second network; and generating, by the network device, a key related information based on the signal.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, related to enabling authentication and key management for application service for roaming users in a wireless communication network.

In one example aspect, a wireless communication method is disclosed. The method includes receiving, by a network device in a first network from a network device in a second network, a signal indicative of an authentication result related to a wireless device, wherein the signal includes a first key and an indication in case that the first network is different from the second network; and generating, by the network device, a key related information based on the signal.

In another example aspect, another wireless communication method is disclosed. The method includes transmitting, by a network device in a second network, a signal indicating of an authentication result related to a wireless device from first network, wherein the signal includes a first key and an indication when the first network is different from the second network.

In another example aspect, another wireless communication method is disclosed. The method includes generating, by a wireless device in a first network, a key related information based on a first key and an indication related to a second network in case that the first network is different from the second network.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIG. 1 shows a diagram of a Service-Based Architecture (SBA) architecture of 5GS for a roaming UE accessing application functions.

FIG. 2 shows an example of enabling Authentication and Key Management for Applications (AKMA) service for roaming users.

FIG. 3 shows another example of enabling AKMA service for roaming users.

FIG. 4 shows an example of a block diagram of an example of a hardware platform that may be a part of a network device or a communication device.

FIG. 5 shows an example of network communication including a base station (BS) and user equipment (UE) based on some implementations of the disclosed technology.

FIGS. 6-8 are flowcharts representation of methods for wireless communication in accordance with one or more embodiments of the present technology.

### DETAILED DESCRIPTION

Section headings are used in the present document to facilitate understanding and do not limit the scope of the disclosed technology to particular sections. Furthermore, certain terminology referring to 5G and Third Generation Partnership Project (3GPP) protocols is used as an illustrative example and the disclosed techniques are applicable to other wireless protocols also.

In a 5G network, a roaming UE in a visited public land mobile network (VPLMN) may need to access an internal application function in a VPLMN or a home public land mobile network (HPLMN).

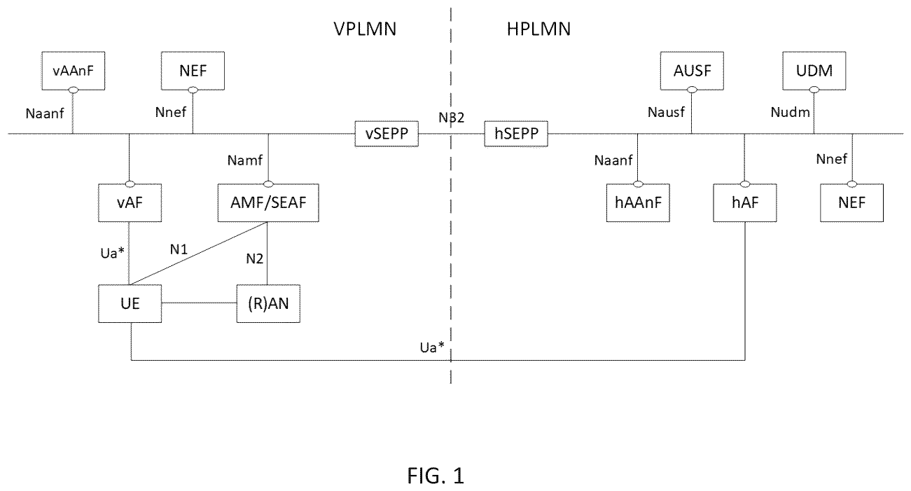

FIG. 1 is the SBA architecture of 5GS for a roaming UE accessing application functions in a VPLMN and a HPLMN. The functionality of related components is described below.

The 5G System architecture consists of the following network functions (NF):

The Access and Mobility Management function (AMF) includes functionality as: UE mobility management, reachability management, connection management, etc.

The Security Anchor Function (SEAF) in the serving network stores the anchor key called the K_{SEAF} provided by the authentication server function (AUSF) of the home network. The K_{SEAF} is derived from keying material generated by the primary authentication and key agreement procedure.

The Authentication Server Function (AUSF) supports authentication for 3GPP access and untrusted non-3GPP access. In AKMA architecture, AUSF provides the Subscription Permanent Identifier (SUPI) and AKMA key material (A-KID, K_{AKMA}) of the UE to the AKMA Anchor Function (AAnF). AUSF also performs the AAnF selection.

The AKMA Anchor Function (AAnF) stores the AKMA Anchor Key (K_{AKMA}) and SUPI for AKMA service, which is received from the AUSF after the UE completes a successful 5G primary authentication. The AAnF also generates the key material to be used between the UE and the Application Function (AF) and maintains UE AKMA contexts. The AAnF sends the SUPI of the UE to AF located inside the operator's network according to the AF request or sends it to NEF.

The Unified Data Management (UDM) stores the subscription profile for the UEs. In AKMA architecture, UDM stores the AKMA subscription data of the subscriber

AKMA roaming scenarios depend on UE and AF locations. There are different scenarios for AKMA roaming that need to be addressed:
Case 1: UE is in VPLMN and accessing an internal HPLMN AF.
Case 2: UE is in VPLMN and accessing an internal VPLMN AF.
Case 3: UE is in VPLMN and accessing an external AF in the Data Network (Internet).

The AKMA roaming solutions should comply with LI requirements. It's required either decrypted traffic or the means (e.g., providing keys) for VPLMN or law enforcement to decrypt the traffic should be provided to VPLMN. The LI requirements for access to keys are only for encryption, and in the AKMA case applies when the Ua* protocol is encrypted. Regarding the means (e.g., providing keys) for VPLMN or law enforcement to decrypt the traffic, for case 1 and case 2, the encryption key (not necessarily the K_{AF} unless K_{AF} is used directly as the encryption key) and related information to decrypt the user traffic need to be provided from the AF to the VPLMN. For Case 3, only the keys and corresponding information which are known to HPLMN and used to establish the encryption key need be provided to VPLMN.

The above are three scenarios of AKMA roaming described in 3GPP S3-224109.

However, under the existing standard for cases 1 and 2, there is no way for the VPLMN functionalities or UE to accurately generate the required key-related information. This is partly due to the lack of information of the encryption key from the HPLMN. The present patent application aims to solve this problem. Specifically, this patent application proposes two mechanisms of enabling AKMA services for roaming cases 1 and 2 in consistence with the existing standard.

### Embodiment 1

This section discloses, among other things, another mechanism to enable AKMA services for roaming cases 1 and 2.

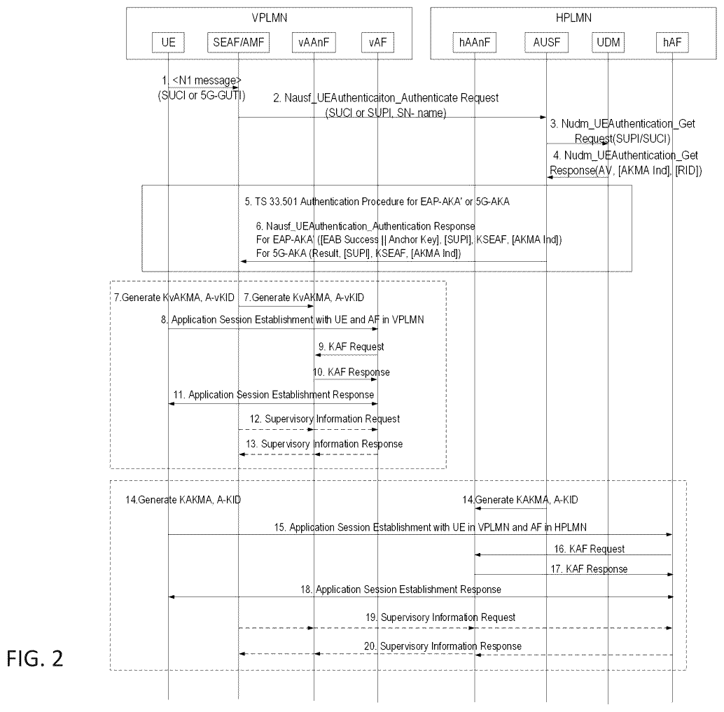

FIG. 2 shows a proposed mechanism for enabling AKMA service for roaming users and providing supervisory information to VPLMN.

Steps 1-4: Steps 1-4 are defined in clause 6.1 of TS 33.535.

Step 5: The rest of the primary authentication procedure is performed as defined in clause 6.1.3 of TS 33.501. Here, step 5 is a general concept, as shown in a block in FIG. 1, which comprises multiple steps, including step 6.

Step 6: During the primary authentication, the AUSF responds to the SEAF in VPLMN with information on the authentication result via Nausf_UE Authentication_Authentication Response. If the UE is from another serving network based on the SN name, the AUSF includes K_{SEAF} and AKMA indication to the SEAF in VPLMN in the response.

Step 7: If the AUSF receives the AKMA indication from the UDM, AKMA key material will be generated.

The roaming UE in VPLMN shall generate the K_{vAKMA} and the A-vKID before initiating communication with an AKMA Application Function. The UE computes:
K_{vAKMA} as in TS 33.535 Annex A.2 using K_{SEAF} instead of K_{AUSF}.
A-vKID as A-KID in TS 33.535 Clause 6.1 with the exception that the realm part of the A-vKID shall include Serving Network Identifier and 5G-GUTI.

The SEAF in VPLMN generates the K_{vAKMA} and the A-vKID computed in the same way as above and sends the AKMA key material to vAAnF.

Step 8: The UE sends an Application Session Establishment Request with A-vKID to vAF.

Step 9: The vAF discovers the vAAnF and sends the Naanf_AKMA_ApplicationKey_Get request with A-vKID and AF_ID to the vAAnF. The vAAnF derives the application key K_{AF} from K_{vAKMA}.

Step 10: The vAAnF responds with Naanf_AKMA_ApplicationKey_Get response containing K_{AF}, K_{AF} expiration time and Registered SN ID.

Step 11: The vAF sends an Application Session Establishment Response to the UE. If the information in Step 10 indicates failure of AKMA key request, the AF shall reject the Application Session Establishment by including a failure cause.

Step 12: The AMF/SEAF in the VPLMN might—if required—request other security information for supervisory purposes to the vAF, e.g., Ua* protocol, security algorithms, etc.

Step 13: The vAF delivers any additional security information for supervisory purposes when available or requested.

Steps 14-20: Steps 14-20 are similar to Steps 7-13, with the differences:
the application function is hAF in the HPLMN.
the AKMA anchor function is hAAnF in the HPLMN.
the roaming UE generates the K_{AKMA} and the A-KID.
the AUSF in HPLMN generates the K_{AKMA} and the A-KID and sends the AKMA key material to hAAnF.
K_{AKMA} is computed as in TS 33.535 Annex A.2 using K_{AUSF}.
A-KID is computed the same as A-KID in TS 33.535 Clause 6.1 except that the realm part of the A-KID shall include Serving Network Identifier and 5G-GUTI.

### Embodiment 2

This section discloses, among other things, another mechanism to enable AKMA services for roaming cases 1 and 2.

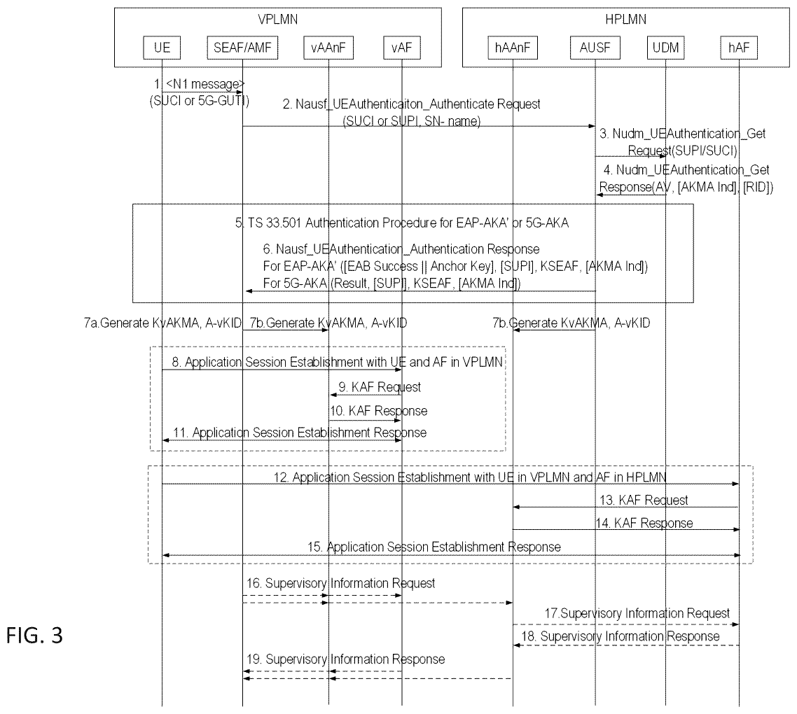

FIG. 3 shows another proposed mechanism for enabling AKMA service for roaming users and providing supervisory information to VPLMN.

Steps: 1-4: Steps 1-4 are defined in clause 6.1 of TS 33.535.

Step 5: The rest of the primary authentication procedure is performed as defined in clause 6.1.3 of TS 33.501.

Step 6: During the primary authentication, the AUSF responds to the SEAF in VPLMN with information on the authentication result via Nausf_UEAuthentication_Authentication Response.

If the UE is from another serving network based on SN name, the AUSF includes K_{SEAF} and AKMA indication to the SEAF in VPLMN in the response.

Step 7: If the AUSF receives the AKMA indication from the UDM, AKMA key material will be generated.

Substep 7a: The roaming UE in VPLMN shall generate the K_{vAKMA} and the A-vKID before initiating communication with an AKMA Application Function. The UE computes:
K_{vAKMA} as in TS 33.535[2] Annex A.2 using K_{SEAF} instead of K_{AUSF}.
A-vKID as A-KID in TS 33.535[2] Clause 6.1 with the exception that the realm part of the A-vKID shall include Serving Network Identifier and 5G-GUTI.

Substep 7b: If the application function is in VPLMN, the SEAF in VPLMN generates the K_{vAKMA} and the A-vKID computed in the same way as above and sends the AKMA key material to vAAnF.

If the application function is in HPLMN, the AUSF in HPLMN generates the K_{vAKMA} and the A-vKID computed in the same way as above and sends the AKMA key material to hAAnF.

Step 8: The UE sends an Application Session Establishment Request with A-vKID to vAF.

Step 9: The vAF discovers the vAAnF and sends the Naanf_AKMA_ApplicationKey_Get request with A-vKID and AF_ID to the vAAnF. The vAAnF derives the application key K_{AF} from K_{vAKMA}.

Step 10: The vAAnF responds with Naanf_AKMA_ApplicationKey_Get response containing K_{AF}, K_{AF} expiration time and Registered SN ID.

Step 11: The vAF sends an Application Session Establishment Response to the UE. If the information in Step 10 indicates failure of AKMA key request, the AF shall reject the Application Session Establishment by including a failure cause.

Steps 12-15: Steps 12-15 are as Steps 8-11, with the difference that the application function is hAF in the HPLMN.

Steps 16-17: The AMF/SEAF in the VPLMN might—if required—request other security information for supervisory purposes to the vAF and/or hAF, e.g., Ua* protocol, security algorithms, etc.

Steps 18-19: The vAF and/or hAF deliver any additional security information for supervisory purposes when available or requested.

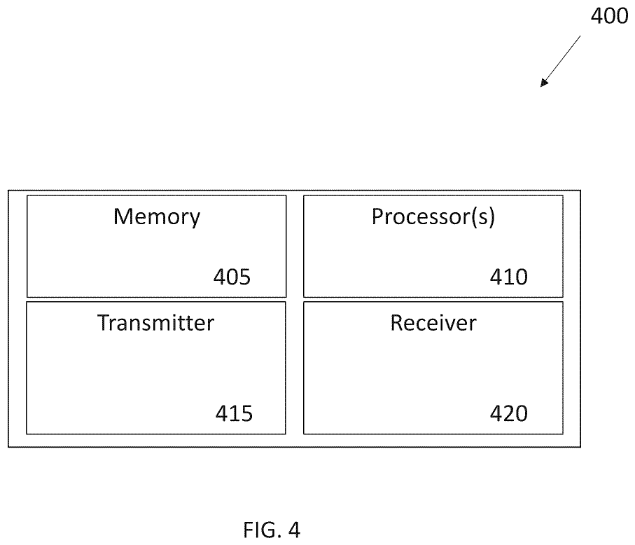

FIG. 4 shows an exemplary block diagram of a hardware platform 400 that may be a part of a network device (e.g., base station) or a communication device (e.g., a user equipment (UE)). The hardware platform 400 includes at least one processor 410 and a memory 405 having instructions stored thereupon. The instructions upon execution by the processor 410 configure the hardware platform 400 to perform the operations described in FIG. 4 and in the various embodiments described in this patent application document. The transmitter 415 transmits or sends information or data to another device. For example, a network device transmitter can send a message to user equipment. The receiver 420 receives information or data transmitted or sent by another device. For example, user equipment can receive a message from a network device.

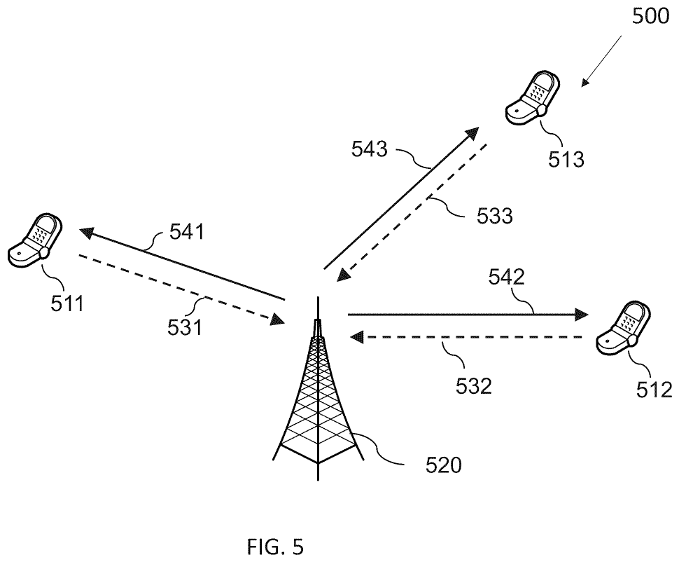

The implementations as discussed above will apply to a network communication. FIG. 5 shows an example of a communication system (e.g., a 6G or NR cellular network) that includes a base station 520 and one or more user equipment (UE) 511, 512 and 513. In some embodiments, the UEs access the BS (e.g., the network) using a communication link to the network (sometimes called uplink direction, as depicted by dashed arrows 531, 532, 533), which then enables subsequent communication (e.g., shown in the direction from the network to the UEs, sometimes called downlink direction, shown by arrows 541, 542, 543) from the BS to the UEs. In some embodiments, the BS send information to the UEs (sometimes called downlink direction, as depicted by arrows 541, 542, 543), which then enables subsequent communication (e.g., shown in the direction from the UEs to the BS, sometimes called uplink direction, shown by dashed arrows 531, 532, 533) from the UEs to the BS. The UE may be, for example, a smartphone, a tablet, a mobile computer, a machine to machine (M2M) device, an Internet of Things (IoT) device, and so on.

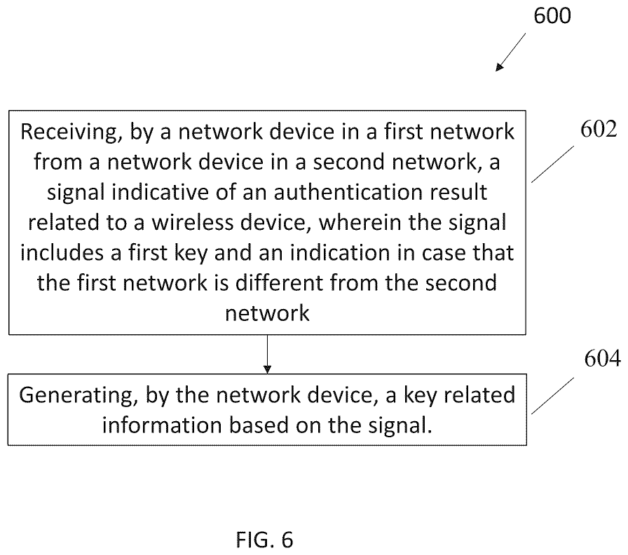

In one example aspect (e.g., as depicted in FIG. 6), a wireless communication method is disclosed. The method includes receiving (602), by a network device in a first network from a network device in a second network, a signal indicative of an authentication result related to a wireless device, wherein the signal includes a first key and an indication in case that the first network is different from the second network; and generating (604), by the network device, a key related information based on the signal.

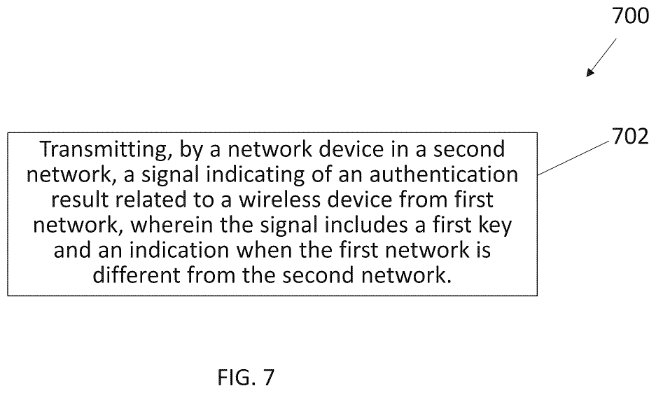

In another example aspect (e.g., as depicted in FIG. 7), another wireless communication method is disclosed. The method includes transmitting (702), by a network device in a second network, a signal indicating of an authentication result related to a wireless device from first network, wherein the signal includes a first key and an indication when the first network is different from the second network.

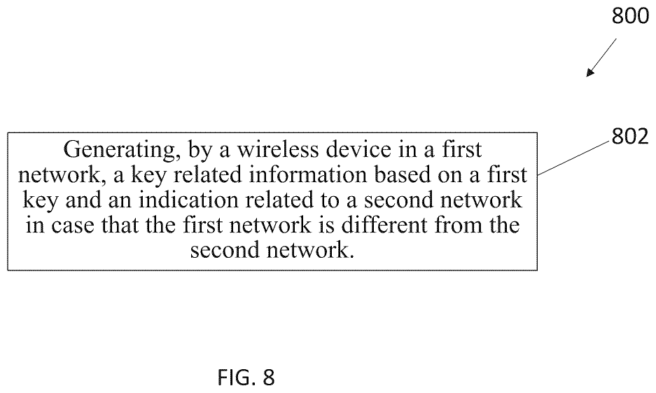

In another example aspect (e.g., as depicted in FIG. 8), another wireless communication method is disclosed. The method includes generating (802), by a wireless device in a first network, a key related information based on a first key and an indication related to a second network in case that the first network is different from the second network.

In some embodiments, the key related information comprises a second key and an identification information of the second key.

In some embodiments, the second key is generated based on the first key.

In some embodiments, the identification information of the second key comprises a network identifier and a user temporary identifier.

In some embodiments, the user temporary identifier is 5G Globally Unique Temporary Identifier (5G-GUTI).

In some embodiments, the above described method further comprising transmitting, by the network device, the key related information to another device in the network as the communication device associated with.

In some embodiments, the network device is an Authentication Server Function (AUSF).

In some embodiments, in the network device is at least one of: 1) a Security Anchor Function (SEAF) or 2) an Access and Mobility Management Function (AMF).

In some embodiments, the wireless device is a user equipment (UE).

In some embodiments, the above-described methods further comprising transmitting, by a second communication device in the second network, the key related information to another device in the second network.

In some embodiments, the second communication device is an Authentication Server Function (AUSF).

It will be appreciated that the present document discloses methods and apparatus related to enabling AKMA service for roaming users in a wireless communication system. There are three scenarios for AKMA roaming. Under current standards, under the existing standard for cases 1 and 2, there is no way for the VPLMN functionalities or UE to generate the required key-related information accurately. No existing methods or schemes have addressed this problem. The present patent application aims to solve this problem by proposing two mechanisms of enabling AKMA services for roaming cases 1 and 2 in consistence with the existing standard.

Various preferred embodiments and additional features of the above-described method of FIGS. 6-8 are as follows. Further examples are described with reference to embodiments 1 to 2.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
receiving, by a network device in a first network from a network device in a second network that is different from the first network, a signal indicative of an authentication result related to a wireless device in the first network, wherein the signal includes a first key and an indication; and
generating, by the network device in the first network, a key related information based on the signal.

2. The method of claim 1, wherein the key related information comprises a second key and an identification information of the second key.

3. The method of claim 2, wherein the second key is generated based on the first key.

4. The method of claim 2, wherein the identification information of the second key comprises a network identifier and a user temporary identifier.

5. The method of claim 4, wherein the user temporary identifier is a 5G Globally Unique Temporary Identifier (5G-GUTI).

6. The method of claim 1, further comprising transmitting, by the network device in the first network, the key related information to another device in the first network the wireless device is associated with.

7. The method of claim 1, wherein the network device in the second network is an Authentication Server Function (AUSF).

8. The method of claim 1, wherein the network device in the first network is at least one of: 1) a Security Anchor Function (SEAF) or 2) an Access and Mobility Management Function (AMF).

9. A method for wireless communication, comprising:
transmitting, by a network device in a second network to a network device in a first network that is different from the second network, a signal indicative of an authentication result related to a wireless device in the first network, wherein the signal includes a first key and an indication, and
wherein when an application function (AF) for the wireless device is located in the second network, the method further comprises:
generating, by the network device in the second network, a key related information based on the first key and the indication;
transmitting, by the network device in the second network, the key related information to another device in the second network.

10. The method of claim 9, wherein the network device in the second network is an Authentication Server Function (AUSF).

11. The method of claim 9, wherein the network device in the first network is at least one of: 1) a Security Anchor Function (SEAF) or 2) an Access and Mobility Management Function (AMF).

12. A method for wireless communication, comprising:
generating, by a wireless device in a first network that is different from a second network, a key related information based on a first key and an indication related to the second network.

13. The method of claim 12, wherein the key related information comprises a second key and an identification information of the second key.

14. The method of claim 13, wherein the second key is generated based on the first key.

15. The method of claim 13, wherein the identification information of the second key comprises a network identifier and a user temporary identifier.

16. The method of claim 15, wherein the user temporary identifier is a 5G Globally Unique Temporary Identifier (5G-GUTI).

17. The method of claim 12, wherein the wireless device is a user equipment (UE).

18. A network communication apparatus in a first network, comprising at least one processor configured to:
receive, from a network device in a second network that is different from the first network, a signal indicative of an authentication result related to a wireless device in the first network, wherein the signal includes a first key and an indication; and
generate a key related information based on the signal.

19. The apparatus of claim 18, wherein the network device in the second network is an Authentication Server Function (AUSF), and
wherein the network communication apparatus in the first network is at least one of: 1) a Security Anchor Function (SEAF) or 2) an Access and Mobility Management Function (AMF).

20. The apparatus of claim 18, wherein the at least one processor is further configured to:
transmit the key related information to another device in the first network the wireless device is associated with.
